(19) United States
(12) Patent Application Publication
(10) Pub. No.: US 2024/0295322 A1
(43) Pub. Date: Sep. 5, 2024

(54) SMART ANTIBACTERIAL COATING APPLIED ON FLAME PRODUCING ASSEMBLY

(71) Applicant: BIC Violex Single Member S.A., Anoixi (GR)

(72) Inventor: Nikolaos CHRYSANTHAKOPOULOS, Anoixi (GR)

(73) Assignee: BIC Violex Single Member S.A., Anoixi (GR)

(21) Appl. No.: 18/574,680

(22) PCT Filed: Jun. 27, 2022
(86) PCT No.: PCT/EP2022/067529

§ 371 Date: Dec. 27, 2023

(30) Foreign Application Priority Data
Jun. 28, 2021 (EP) 21182101.2

(51) Int. Cl. F23Q 2/50; A01N 37/18; A01N 59/00; A01N 63/50; A01P 1/00

(52) U.S. Cl. CPC F23Q 2/50; A01N 37/18; A01N 59/00; A01N 63/50; A01P 1/00

(57) ABSTRACT

The present disclosure relates to a flame producing assembly, such as a lighter. The flame producing assembly of the present disclosure is characterized by an antibacterial coating. In addition, according to the present disclosure the antibacterial coating is configured to at least partially destroy and/or inactivate pathogens on the antibacterial coating.

### CROSS REFERENCE TO RELATED APPLICATIONS

This is a National Stage Application under 35 U.S.C. § 371 of International Application No. PCT/EP2022/067529, filed Jun. 27, 2022, now published as WO 2023/274936 A1, which claims priority to European Patent Application No. EP 21182101.2, filed on Jun. 28, 2021, the entireties of which are incorporated herein by reference.

### TECHNICAL FIELD

The present invention relates to the field of flame producing assemblies comprising smart coatings. More specifically, the present invention relates to flame producing assemblies such as lighters, comprising thermally activated smart antibacterial coatings.

### BACKGROUND

The present disclosure relates to flame producing assemblies, such as lighters, which comprise thermally activated smart antibacterial coatings. Flame producing assemblies are commonly handheld devices. Surfaces of flame producing assemblies may be contaminated with pathogens. In particular, surfaces used for handling a flame producing assembly such as the flame producing assembly body, may be contaminated. Sources of contamination may be for example the environment where the flame producing assembly is kept e.g. trouser pockets or the hands of the user. As a result, flame producing assemblies may become a source of infection, especially when the flame producing assembly is used by multiple users.

The present disclosure aims to address one or more problems in the prior art.

### SUMMARY

In a first aspect, the present disclosure relates to a flame producing assembly characterized by an antibacterial coating, wherein the antibacterial coating is configured to at least partially destroy and/or inactivate pathogens on the antibacterial coating.

In some embodiments, the antibacterial coating may be configured to at least partially destroy and/or inactivate pathogens on the antibacterial coating below a first transition temperature.

In some embodiments, the antibacterial coating may be configured to at least partially repel pathogens and/or remnants thereof.

In some embodiments, the antibacterial coating may be configured to at least partially repel pathogens and/or remnants thereof above a second transition temperature.

In some embodiments, the antibacterial coating comprises a bactericidal component and an antifouling component.

In some embodiments, the bactericidal component may comprise a bactericidal agent comprising an antibiotic, an antimicrobial peptide, a polycationic polymer, metal ions, nitric oxide, a nanosized metal, a nanosized metal oxide, an antimicrobial enzyme, a quaternary ammonium salt, an N-halamine and/or a quorum sensing inhibitor.

In some embodiments, the antifouling component may be hydrophobic or may be hydrophilic.

In some embodiments, the antibacterial coating may be configured to expose the bactericidal component at the outer surface at temperatures below the first transition temperature and to expose the antifouling component at the outer surface at temperatures above the second transition temperature.

In some embodiments, the bactericidal component or parts thereof may be configured to undergo a conformation change when heated above the second transition temperature and to reverse the conformation change when cooling to a temperature below the first transition temperature.

In some embodiments, the bactericidal component may be configured to be in an elongated state at temperatures below the first transition temperature, thereby extending from the outer surface. Additionally or alternatively, the bactericidal component may be in a collapsed state at temperatures above the second transition temperature, thereby resting on the outer surface and/or retracting into the outer surface.

In some embodiments, the bactericidal component may comprise a thermoresponsive polymer.

In some embodiments, the thermoresponsive polymer may comprise poly(N-vinyl caprolactam), poly(N-isopropylacrylamide) and/or poly(N-isopropylacrylamide) co-polymer, more specifically wherein the poly(N-isopropylacrylamide) co-polymer comprises poly(N-isopropylacrylamide-co-caprolactam) and/or poly(N-isopropylacrylamide-co-2-carboxyethyl acrylate).

In some embodiments, the first transition temperature may be a lower critical solution temperature of the thermoresponsive polymer, more specifically wherein the lower critical solution temperature is between about 30° C. to about 50° C., more specifically between about 35° C. and about 45° C., and in particular between about 37° C. and about 43° C.

In some embodiments, the antifouling component may form an outer surface of the antibacterial coating, more specifically wherein the bactericidal component is bound to the antifouling component or parts thereof.

In some embodiments, the first transition temperature and the second transition temperature may be the same temperature.

### BRIEF DESCRIPTION OF THE DRAWINGS

FIG. 1 Schematic of a flame producing assembly according to an embodiment

FIG. 2 Schematic of the antibacterial coating destroying and repelling pathogens or remnants thereof

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

Flame producing assemblies, such as lighters, are commonly designed having a container to store a flammable material, that will be ignited to produce a flame. The flammable material is generally a liquefied petroleum gas (LPG), that is filled under pressure in the container of the lighter through a filling valve of the lighter. During release of the LPG from the container through a release device, in particular an exit valve arranged in the lighter, the gas expands and is mixed with the direct surrounding air. The mixture of gas with the oxygen contained in the surrounding air is ignited at the exit valve of the lighter to produce a flame. However, flame producing assemblies may be contaminated by pathogens.

Accordingly, in a first aspect, the present disclosure relates to a flame producing assembly characterized by an antibacterial coating, wherein the antibacterial coating is configured to at least partially destroy and/or inactivate pathogens on the antibacterial coating. Since the flame producing assembly comprises an antibacterial coating configured to at least partially destroy and/or inactivate pathogens the device may reduce the risk of pathogen transmission to users.

The term “pathogen” within this disclosure shall refer to a microorganism or agent that can produce a disease, in particular a disease in a human.

The term “destroy pathogens” within this disclosure shall refer to a process wherein pathogens that were able to reproduce by themselves or within a host, are not able reproduce anymore even if transferred to a new environment. For example, for bacteria this may refer to the bacteria being killed and for viruses it may refer to a damage to their hull or genetic information which prevents them from being reproduced within a host cell.

The term “inactivation of pathogens” within this disclosure shall refer to a process wherein pathogens that were able to reproduce, are not able to reproduce anymore in the present environment. For example, for bacteria this may refer to an inability of cell division within the present environment.

In some embodiments, the antibacterial coating may be configured to at least partially destroy and/or inactivate pathogens on the antibacterial coating below a first transition temperature.

In some embodiments, the antibacterial coating may be configured to at least partially repel pathogens and/or remnants thereof. The term “repel” within this disclosure shall refer to a reduction of adhesion, in particular the reduction of adhesion between a pathogen or remnant thereof and a surface. Antibacterial coatings may become covered by pathogens and/or pathogen remnants. The layer of pathogens or pathogen remnants may interfere with the antibacterial action. Without wishing to be bound by theory, pathogens may attach to an antibacterial coating. Subsequently, the deposited pathogens may be at least partially destroyed and/or inactivated on the surface. The pathogen remnants may form a layer on the antibacterial coating. Subsequently deposited pathogens may attach to the layer of pathogens and/or remnants thereof and therefore not come into contact with the antibacterial layer. As a result, pathogens attached to the layer of remnants may not be destroyed and/or inactivated by the antibacterial coating. Thus, pathogens attached to the layer of remnants may remain a risk for infection or even propagate on the surface. An antibacterial coating configured to at least partially repel pathogens and/or remnants thereof may prevent or reduce the layer formation. As a result, an antibacterial coating configured to at least partially repel pathogens and/or remnants thereof may prevent pathogens becoming attached to a surface without coming into direct contact with the antibacterial coating.

In some embodiments, the antibacterial coating may be configured to at least partially repel pathogens and/or remnants thereof above a second transition temperature. An antibacterial coating that is configured to at least partially destroy and/or inactivate pathogens below the first transition temperature and at least partially repel pathogens and/or remnants thereof above the second transition temperature may create a synergistic effect. At temperatures below the first transition temperature the antibacterial coating may at least partially destroy and/or inactivate pathogens. When the antibacterial coating is heated to a temperature above the second transition temperature it may repel at least partially repel pathogens and/or remnants thereof, thereby cleaning the surface. Subsequently, when the antibacterial coating cools to a temperature below the first transition temperature, pathogens attaching to the surface may come into contact with the antibacterial coating.

The antibacterial coatings abilities to “at least partially destroy and/or inactivate pathogens” and to “at least partially repel pathogens and/or remnants thereof” may be regarded as two modes of action provided by the antibacterial coating. The antibacterial coating may switch between these modes of action depending upon the temperature.

In some embodiments, the antibacterial coating may comprise a bactericidal component and an antifouling component. In some embodiments, the antifouling component may form an outer surface of the antibacterial coating. In some embodiments, the bactericidal component may be bound to the antifouling component or parts thereof. In some embodiments, the antibacterial coating may be configured to expose the bactericidal component at the outer surface at temperatures below the first transition temperature and to expose the antifouling component at the outer surface at temperatures above the second transition temperature. In some embodiments, the bactericidal component may be exposed at the outer surface below the first transition temperature to destroy and/or inactivate pathogens present at the outer surface. Further, the antifouling component may be exposed at the outer surface at temperatures above the second transition temperature to repel pathogens present at the outer surface.

In some embodiments, the bactericidal component or parts thereof may be configured to undergo a conformation change when heated above the second transition temperature and to reverse the conformation change when cooling to a temperature below the first transition temperature. In some embodiments, the bactericidal component may be configured to be in an elongated state at temperatures below the first transition temperature, thereby extending from the outer surface. Additionally or alternatively, the bactericidal component may be in a collapsed state at temperatures above the second transition temperature, thereby resting on the outer surface and/or retracting into the outer surface.

In some embodiments, the antifouling component may be hydrophobic, in particular superhydrophobic. The term “hydrophobic” may inter alia refer to its common meaning in the art. Additionally or alternatively, the term “hydrophobic” may refer to a material property, wherein the material exhibits a contact angle of at least 100°, more specifically at least 110° and in particular at least 120°. The term “superhydrophobic” may inter alia refer to its common meaning in the art. The term “superhydrophobic” may refer to a material property, wherein the material exhibits a contact angle of at least 150°. Additionally or alternatively, the term “superhydrophobic” may refer to a material property, wherein the material exhibits a contact angle of at least 150° and a contact angle hysteresis of less than 5°. A hydrophobic component may at least partially repel pathogens. Some pathogens may not or only weakly attach to hydrophobic surfaces or may be repelled by hydrophobic surfaces. In some embodiments, the antibacterial coating may exhibit a contact angle of at least 100°, more specifically at least 110°, even more specifically at least 120° and in particular at least 150°, when the antibacterial exhibits a temperature above the second transition temperature.

In some embodiments, the antifouling component may be hydrophilic, in particular superhydrophilic. A hydrophilic component may reduce the probability of proteins to binding thereto, in particular by forming a hydration layer forming an energetic and/or physical barrier, which may prevent the proteins binding to the hydrophilic component. The term “hydrophilic” may inter alia refer to its common meaning in the art. Additionally or alternatively, the term “hydrophilic” may refer to a material property, wherein the material exhibits a contact angle of less than 50°, more specifically less than 30° and in particular less than 15°. The term “superhydrophilic” may inter alia refer to its common meaning in the art. The term “superhydrophilic” may refer to a material property, wherein the material exhibits a contact angle of less than 5°, in particular about 0°.

In some embodiments, the antibacterial coating may exhibit a contact angle of less than 50°, more specifically less than 30°, even more specifically less than 15° and in particular about 0°, when the antibacterial exhibits a temperature above the second transition temperature.

In some embodiments, the bactericidal component may comprise a thermoresponsive polymer 26. Thermoresponsive polymers 22 are known in the art. The term “thermoresponsive polymer” commonly refers to polymers that exhibit a drastic and discontinuous change of their physical properties with temperature. Some thermoresponsive polymers 22 may exhibit a drastic, discontinuous and reversible change of their conformation with temperature. For example, a thermoresponsive polymer 26 may be attached to a surface and may be present in an extended state at temperatures below the first transition temperature. At temperatures above the second transition temperature the thermoresponsive polymer 26 may be in a coiled or folded state.

In some embodiments, the thermoresponsive polymer 26 may comprise poly(N-vinyl caprolactam). In some embodiments, the thermoresponsive polymer 26 may comprise poly(N-isopropylacrylamide). In some embodiments, the thermoresponsive polymer (26) may comprise a poly(N-isopropylacrylamide) co-polymer. In some embodiments, the poly(N-isopropylacrylamide) co-polymer may comprise poly(N-isopropylacrylamide-co-caprolactam) and/or poly(N-isopropylacrylamide-co-2-carboxyethyl acrylate). The choice of polymer may rely upon different factors, for example price, transition temperature or attachability of functional groups.

In some embodiments, the first transition temperature may be a lower critical solution temperature of the thermoresponsive polymer 26. The lower critical solution temperature of a thermoresponsive polymer 26 is commonly the temperature at which the thermoresponsive polymer 26 exhibits its drastic and discontinuous change of physical properties.

In some embodiments, the second transition temperature may be the lower critical solution temperature of the thermoresponsive polymer 26.

The thermoresponsive polymer 26 may be subjected to hysteresis. As a result, when the polymer is heated it may not exhibit the change of physical properties exactly at the lower critical solution temperature but at a temperature around it. In particular, the hysteresis width ΔH, i.e. the difference between two transition temperatures at which the physical properties of the polymer change, can range from 1 to 10° C., for example a hysteresis width of +5° C. When the polymer is heated, the hysteresis will usually lead to the temperature at which the change of physical properties occurs to be shifted to a higher temperature. The shift of temperature may depend, among other factors, upon the heating rate. A greater heating rate will commonly lead to a greater shift of temperature. When cooling the polymer, the hysteresis will commonly shift the temperature at which the change occurs to a lower temperature. Analogously, a greater cooling rate may lead to a greater shift of temperature. As a result, the thermoresponsive polymer 26 may have a first and second transition temperature, wherein the difference between the two transition temperatures is caused by hysteresis. As explained above, the temperature difference, and thereby the first and second transition temperature, may change depending on other factors, e.g. the rate of heating and cooling. The properties of the antibacterial coating at temperatures between the first and second transition temperature may not be clearly definable. At temperatures between the first and second transition temperature, the properties of antibacterial coating may comprise pathogen destroying and/or inactivating properties and pathogen repelling properties at the same time. Further, the properties of the antibacterial coating may vary along its surface.

In some embodiments, the first transition temperature and the second transition temperature may be the same temperature. The first transition temperature and second transition temperature may be the same temperature, in particular if the thermoresponsive polymer 26 is unaffected by hysteresis (i.e. when the thermoresponsive polymer does not exhibit hysteresis) and/or the heating and cooling rates are sufficiently small.

Other factors may influence the first and second transition temperature or lower critical solution temperature. For example, the molecular weight of the polymer, the presence of water or salts and/or molecules attached to the polymer may alter the transition temperature. Further, as polymers commonly have a molecular weight distribution, not the entirety of the thermoresponsive polymer 26s present in a coating may change their conformation at the same temperature.

In some embodiments, the first transition temperature may be between about 30° C. to about 50° C., more specifically between about 35° C. and about 45° C., and in particular between about 37° C. and about 43° C. A first transition temperature within the temperature ranges described above may allow the antibacterial coating to switch its mode of action above ambient temperature, but below a temperature that may be uncomfortable or hazardous to the user. In embodiments, the mode of action may be switched above the ambient temperature as the coating may be cooled by ambient air after the flame producing assembly has been extinguished, thus reverting the coating to its former state.

In some embodiments, the second transition temperature may be between about 30° C. to about 50° C., more specifically between about 35° C. and about 45° C., and in particular between about 37° C. and about 43° C. A second transition temperature within the temperature ranges described above may allow the antibacterial coating to switch its mode of action above ambient temperature, but below a temperature that may be uncomfortable or hazardous to the user. In embodiments, the mode of action may be switched above the ambient temperature as the coating may be cooled by ambient air after the flame producing assembly has been extinguished, thus reverting the coating to its former state.

In some embodiments, the lower critical solution temperature may be between about 30° C. to about 50° C., more specifically between about 35° C. and about 45° C., and in particular between about 37° C. and about 43° C. A lower critical solution temperature within the temperature ranges described above may allow the thermoresponsive polymer 26 to switch its conformation above ambient temperature, but below a temperature that may be uncomfortable or hazardous to the user. Thermoresponsive polymer 26 may switch its conformation above the ambient temperature. The coating may be cooled by the environment, for example ambient air, after the flame producing assembly has been extinguished, thus reverting the thermoresponsive polymer 26 to its former state.

FIG. 2 shows schematics of the mode of action of the antibacterial coating. On the left side of the image an antibacterial coating is shown with a temperature below the first transition temperature. A pathogen attaches in step “A” to the thermoresponsive polymer 26 comprising a bactericidal agent 24 and may be destroyed. In step “B” the pathogen or remnants thereof are repelled, as the antibacterial coating is heated above the second transition temperature and the thermoresponsive polymer 26 retracts and exposes the antifouling-polymer 22. Step “C” shows how a pathogen is repelled before attaching, as the antibacterial coating is at a temperature above the second transition temperature.

In some embodiments, the bactericidal component may comprise a bactericidal agent 24. A bactericidal agent 24 may be used in circumstances for destroying and/or inactivating bacteria.

In some embodiments, the bactericidal agent 24 may comprise an antibiotic, an antimicrobial peptide, a polycationic polymer, metal ions, nitric oxide, a nanosized metal, a nanosized metal oxide, an antimicrobial enzyme, a quaternary ammonium salt, an N-halamine and/or a quorum sensing inhibitor.

In some embodiments, the bactericidal agent 24 may be covalently bonded to components of the bactericidal component.

In some embodiments, the bactericidal agent 24 may be covalently bonded to the thermoresponsive polymer 26. A covalent bond may prevent the release of the bactericidal agent 24 from the bactericidal component. A loss of the bactericidal agent 24 may lead to the bactericidal component not being able to at least partially destroy and/or inactivate pathogens.

Binding the bactericidal agent 24 to components of the bactericidal component, in particular the thermoresponsive polymer 26 may assist the switching of the mode of action. The bactericidal component bound to the thermoresponsive polymer 26 may be present at the outer surface at temperatures below the first transition temperature, as the thermoresponsive polymer 26 may be in an extended state. At temperatures above the second transition temperature the bactericidal component may be retracted, as the thermoresponsive polymer 26 may coil or fold into a retracted position.

In some embodiments, the bactericidal agent 24 may be vancomycin, a B-lactam, a glycopeptide, a polyketide, a lincosamide, aminoglykosid, a polypeptide, a lipopeptide, an epoxide, a chinolon, a streptogramine, a sulfonamide, an oxazolidinone, ansamycine or a nitroimidazole or mixtures thereof. In some embodiments the bactericidal agent 24 may comprise silver, in particular silver nanomaterials, and/or silver ions, in particular silver sulfadiazine. The bactericidal agents 24 may also be used in combination, for example to cover a wider range of pathogens or to prevent the development of resistances. In embodiments, a bactericidal agent 24 or combination of bactericidal agents 24 with a broad spectrum of effectiveness may be used.

In some embodiments, the antifouling component may comprise an antifouling-polymer 22 configured to repel bacteria.

In some embodiments, the antifouling-polymer may be hydrophobic, in particular superhydrophobic. Examples of hydrophobic polymers are fluorinated silanes or fluoropolymers. Further, the antifouling-polymer may comprise nano-composites such as manganese oxide polystyrene. As mentioned above, a hydrophobic component may at least partially repel pathogens. Some pathogens may not attach to hydrophobic surfaces or be repelled by hydrophobic surfaces.

In some embodiments, the antifouling polymers may be hydrophilic, more specifically superhydrophilic. In some embodiments, the antifouling-polymer 22 may comprise poly(sulfobetaine methacrylate) and/or polycarboxybetaine.

In some embodiments, the bactericidal component may be covalently bonded to the antifouling-polymer 22 or parts thereof.

In some embodiments, the thermoresponsive polymer 26 may be covalently bonded to the antifouling-polymer 22 or parts thereof.

Covalently binding the thermoresponsive polymer 26 and/or bactericidal component to the antifouling-polymer 22 may result in a stable layer structure. In particular, if the thermoresponsive polymer 26 is covalently bonded to the antifouling-polymer 22, at temperatures below the first transition temperature the thermoresponsive polymer 26 may extend from the surface and come into contact with pathogens. At temperatures above the second transition temperature the thermoresponsive polymer 26 may coil or fold and rest upon the antifouling-polymer 22 and/or retract into voids in the antifouling-polymer 22. Hence, at temperatures above the second transition temperature pathogens and/or remnants thereof present on the surface may be exposed to the anti-fouling polymer. As a result, at temperatures above the second transition temperature pathogens and/or remnants thereof may be repelled from the surface by the anti-fouling polymer. Pathogens may still be exposed to the bactericidal component above the second transition temperature if the thermoresponsive polymer 26 does not retract into voids in the antifouling-polymer 22. Hence, at temperatures above the second transition temperature the antibacterial coating may still at least partially destroy and/or inactivate pathogens, although at a reduced rate compared to temperatures below the first transition temperature. The retraction of the polymer may depend upon the polymer itself, e.g. molecular weight, and upon the size of voids within the antifouling-polymer 22.

In some embodiments, the flame producing assembly may comprise a heat conductive layer 28. Additionally or alternatively, the heat conductive layer 28 may be configured to transfer thermal energy generated by a flame of the flame producing assembly to the antibacterial coating.

Transferring thermal energy generated by the of the flame producing assembly to the antibacterial coating may aid the antibacterial coating in switching its mode of action. When the flame producing assembly is not used, the temperature of the antibacterial coating may be below the first transition temperature, especially if the ambient temperature is below the first transition temperature. As a result, the antibacterial coating may at least partially destroy and/or inactivate pathogens, when the flame producing assembly is not used. When the flame producing assembly is used to generate a flame, part of the thermal energy may be transferred to the antibacterial coating through the heat conductive layer 28. The temperature of the antibacterial may be raised above the second transition temperature due to the provided thermal energy. As a result, the antibacterial coating may then at least partially repel pathogens or remnants thereof. When the flame generation is stopped, the temperature of the antibacterial may fall below the first transition temperature, especially if the ambient temperature is below the first transition temperature. As a result, the antibacterial coating may again at least partially destroy and/or inactivate pathogens.

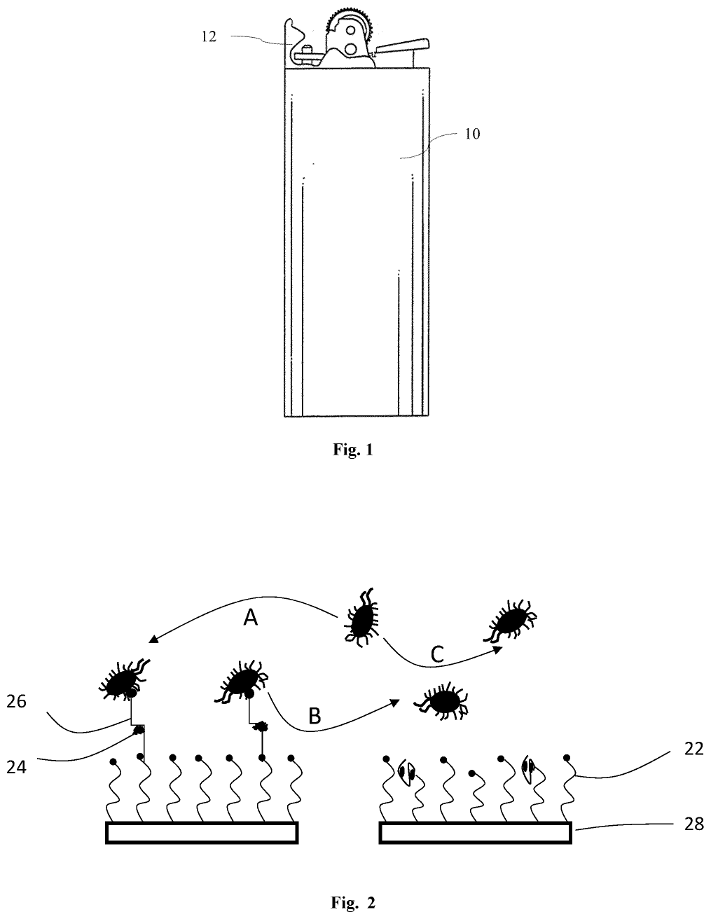

In some embodiments, the flame producing assembly may comprise a flame producing assembly body. FIG. 1 shows a flame producing assembly comprising a flame producing assembly body 10. Additionally or alternatively, the flame producing assembly body 10 may comprise at least one outer surface and at least one inner surface. Additionally or alternatively, the heat conductive layer 28 may be applied to at least one of the flame producing assembly body's outer surface(s) or parts thereof. Additionally or alternatively, the flame producing assembly body 10 or parts thereof may comprise the heat conductive layer 28.

In some embodiments, the antibacterial coating may be in thermal contact with the heat conductive layer 28. In some embodiments, the antibacterial coating may be applied to the heat conductive layer 28. As mentioned above it may be of interest that the heat conductive layer 28 transfers heat to the antibacterial coating. Therefore, the heat conductive layer 28 and the antibacterial coating may be in thermal contact. When the antibacterial coating is applied to and/or comprised within the flame producing assembly body 10, the antibacterial coating may be applied to the heat conductive layer 28 to achieve a large interface between the antibacterial coating and the heat conductive layer 28. A large interface may provide a faster rate of thermal energy transfer between the heat conductive layer 28 and the antibacterial coating.

Furthermore, the flame producing assembly body 10 may comprise the surfaces which come into contact with users the most. In particular, surfaces of the flame producing assembly body 10 may be used by the user to hold the device. As a result, it may be advantageous to coat the flame producing assembly body 10 with the antibacterial coating, as it may comprise the surfaces that pose the biggest risk for pathogen transmission.

In some embodiments, wherein the flame producing assembly may comprise a hood. In some embodiments, the hood may be in thermal contact with the heat conductive layer 28. It may be advantageous that the hood is in thermal contact with the heat conductive layer 28, as the hood of a flame producing assembly often absorbs significant amounts of thermal energy from the flame, for example from thermal radiation.

In some embodiments, the heat conductive layer 28 may comprise a metal, in particular copper, platinum, gold, iron and/or steel. A heat conductive metal comprising one of the aforementioned metals may be beneficial as they may have a high thermal conductivity. A high thermal conductivity may be beneficial to quickly transfer throughout the heat conductive layer 28 and in turn to the antibacterial coating.

In some embodiments, the heat conductive layer 28 may comprise a ceramic. Some ceramics, for example aluminum nitride, may provide high thermal conductivity, as well as good mechanical properties, while being relatively chemically inert.

In some embodiments, the heat conductive layer 28 may comprise a polymer, in particular a polyethylene. In some embodiments, the heat conductive layer 28 may comprise nanofibers. In some embodiments, the nanofibers may comprise amorphous and crystalline regions. In particular, a heat conductive layer 28 comprising polyethylene may comprise nanofibers and amorphous domains. In particular, highly oriented polyethylene films may provide a high thermal conductivity. The highly oriented polyethylene film may have amorphous domains which are minimally entangled and the chains maximally aligned. The minimally entangled amorphous domains and minimally entangled chains may provide a high thermal conductivity.

In some embodiments, the thermal conductivity of the heat conductive layer 28 may be above about

$$8 \frac{W}{m * K} ,$$

more specifically above about

$$12 \frac{W}{m * K}$$

and in particular above about

$$16 \frac{W}{m * K} .$$

In some embodiments, the thermal conductivity of the polyethylene may be above about

$$8 \frac{W}{m * K} ,$$

more specifically above about

$$12 \frac{W}{m * K}$$

and in particular above about

$$16 \frac{W}{m * K} .$$

A heat conducive layer (28) with a thermal conductivity may be advantageous to achieve a fast transfer of thermal energy from the flame and/or heat absorbing element to the antibacterial coating.

In some embodiments, the antibacterial coating may be thermally conductive. The term “thermally conductive” within this disclosure may i.a. refer to its common meaning in the art. Additionally or alternatively, the term “thermally conductive” may refer to a material with a thermal conductivity of at least

$$1 \frac{W}{m * K} ,$$

more specifically at least

$$4 \frac{W}{m * K}$$

and in particular at least about

$$8 \frac{W}{m * K} .$$

In some embodiments, the antibacterial coating may comprise thermally conductive fillers. The thermally conductive fillers, e.g. inorganic or metal particles, may increase the antibacterial coating's thermal conductivity.

In some embodiments, the flame producing assembly may comprise a heat absorbing element 12. In some embodiments, the heat absorbing element 12 may protrude into the flame. In some embodiments, the heat absorbing element 12 may be in thermal contact with the heat conductive layer 28. A heat absorbing element 12 protruding into the flame may efficiently and quickly provide thermal energy to the heat conductive layer 28. The thermal energy may be subsequently conducted to the antibacterial coating.

In some embodiments, the heat absorbing element 12 may be connected to a phase change material, more specifically a solid-solid phase change material and in particular a metallic phase change material. A solid-solid phase change material connected to a heat absorbing element 12 may be beneficial as it may store thermal energy due to the phase change reaction. As a result, the heat absorbing element 12 may absorb thermal energy from the flame generated by the flame producing assembly. Subsequently, the phase change material may provide thermal energy after the flame generated by the flame producing assembly has been extinguished, in particular it may provide thermal energy to the heat absorbing element 12. The thermal energy may then be transferred to the antibacterial coating. The longer provision of thermal energy may keep ultimately lead to the temperature of the antibacterial coating staying at a temperature above second transition temperature for a longer a time. As a result, the antibacterial coating may be able to repel pathogens and remnants thereof for a longer time. Further, the phase change material may prevent heat spikes by absorbing part of the thermal energy while the flame produced by the flame producing assembly is active. A heat absorbing element 12 comprising a phase change material may be advantageous compared to other heat absorbing element 12, as it may have a high specific heat capacity, which may reduce the weight and volume required. Further, a heat absorbing element 12 comprising a phase change material may be advantageous as it may not be heated above a certain temperature, unless an extensively high amount of thermal energy is delivered to it. As a result, the heat absorbing element 12 comprising a phase change material may not be heated above a possibly hazardous temperature. Further, as the heat absorbing element 12 may be in thermal contact with other parts of the flame producing assembly, the phase change material may also prevent other parts from reaching possibly hazardous temperatures.

In some embodiments, the solid-solid phase change material may comprise SAN-g-PA, cellulose-g-PEG, neopentyl glycol-tris(hydroxymetahl)aminomethane, C₁₀Cu, C₁₆Cu, Fe-20CO, FE-40CO. In some embodiments, heat absorbing element 12 may consist of an aluminum-silicon alloy. In some embodiments, the heat absorbing element 12 may have a melting point of at least about 800° C., more specifically at least about 1100° C. and in particular at least about 1400° C. A heat absorbing element 12 with a high melting point may be advantageous, as it may not melt when exposed to the flame. Melting of the heat absorbing element 12 may destroy the heat absorbing element 12 and/or the flame producing assembly.

In some embodiments, the heat absorbing element 12 may be conically, cylindrically, ring, spherically, half-spherically or ovaloid shaped. The choice of shape may rely upon design considerations, e.g. the desired rate of thermal energy adsorption.

In some embodiments, the flame producing assembly may comprise an overheat protection, wherein the overheat protection is configured to stop or reduce the heat influx to the heat conductive layer 28 at a limiting temperature. In some embodiments, the flame producing assembly may comprise an overheat protection, wherein the overheat protection is configured to stop or reduce the heat influx from the heat absorbing element 12 to the heat conductive layer 28 at a limiting temperature. In some embodiments, the limiting temperature may be between about 40° C. to about 60° C., more specifically between about 45° C. and about 55° C., and in particular between about 47° C. and about 53° C. The limiting temperature may be defined as the temperature of the overheat protection, heat conductive layer 28 or antibacterial coating. In particular, the limiting temperature may be defined as the temperature of the overheat protection in its coolest region. In some embodiments, the overheat protection may be configured to connect the heat absorbing element 12 and the heat conductive layer 28 below the limiting temperature and to disconnect the heat absorbing element 12 and the heat conductive layer 28 above the limiting temperature. An overheat protection, in particular an overheat protection configured to disconnect the heat absorbing element 12 and the heat conductive layer 28 above the above mentioned limiting temperatures may be beneficial to the user. In particular, the overheat protection may prevent the surface of the flame producing assembly in contact with the skin of the user to heat to temperatures that may be uncomfortable and/or hazardous to the user.

In some embodiments, the overheat protection may comprise a bimetallic actuator. In some embodiments, the overheat protection may be a bimorph actuator. In some embodiments, the overheat protection may be a bent beam actuator. In some embodiments, the heat absorbing element 12 may be made of a bimetal, wherein the heat absorbing element 12 is configured to bend away from the flame when heated.

In some embodiments, the flame producing assembly may comprise an insulating layer, in particular thermally insulating layer. In some embodiments, the antibacterial coating may exhibit a higher thermal conductivity compared to the insulating layer. In some embodiments, the insulating layer may be applied between the flame producing assembly body 10 and the heat conductive layer 28. In some embodiments, the insulating layer may be applied on one or more of the flame producing assembly body's inner surface(s). An insulating layer, in particular an insulating layer between the flame producing assembly body 10 and the heat conductive layer 28, may be beneficial to more efficiently provide the thermal energy to the antibacterial coating as the dissipation into other directions is reduced. Further, other components of the flame producing assembly may be protected from the heat. For example if the flame producing assembly comprises a fuel storage within the flame producing assembly body 10, the thermal energy may heat the fuel. Heating of the fuel may be hazardous. The term “thermally insulating” within this disclosure may i.a. refer to its common meaning in the art. Additionally or alternatively, the term “thermally insulating” may refer to a material with a thermal conductivity of less than

$$1 \frac{W}{m * K} ,$$

more specifically less than

$$0.1 \frac{W}{m * K}$$

and in particular at less than

$$0.05 \frac{W}{m * K} .$$

In some embodiments, the flame producing assembly may comprise a thermochromic coating. In some embodiments, the thermochromic coating may change color at a temperature between about 30° C. to about 50° C., more specifically between about 35° C. and about 45° C., and in particular between about 37° C. and about 43° C. In some embodiments, the thermochromic coating may be applied to the heat conductive layer 28 or parts thereof. In some embodiments, the thermochromic coating may be applied to the antibacterial coating or parts thereof. A thermochromic coating changing colors at specific temperatures may indicate to the user whether the antibacterial coating has been heated above the second transition temperature. This may indicate to the user, whether the antibacterial coating has been sufficiently heated to switch its mode of action, in particular whether the antibacterial coating has been sufficiently heated to at least partially repel pathogens or parts thereof. In some embodiments it may be advantageous to only coat parts of the antibacterial coating with the thermochromic coating, as parts that are coated by the thermochromic coating may not destroy, inactivate and/or repel pathogens.

In some embodiments, the thermochromic coating may comprise thermochromic liquid crystals. In some embodiments, the thermochromic coating may comprise a leuco dye. In some embodiments, the thermochromic coating comprises one or more microcapsules, wherein the microcapsule(s) may comprise a leuco dye, in particular spirolactones, fluorans, spiropyrans and/or fulgides, a weak acid, and a salt.

In some embodiments, the pathogens may be bacteria, parasites, algae, fungi and/or viruses and in particular bacteria.

In some embodiments, the antibacterial coating may destroy and/or inactivate at least about 30%, more specifically at least about 50% and in particular at least about 70% of pathogens on the antibacterial coating within one hour at a temperature below the first transition temperature.

In some embodiments, the antibacterial coating may repel at least about 20%, more specifically at least about 40% and in particular at least about 60% of pathogens within one hour at a temperature above the second transition temperature compared to the number of pathogens on the antibacterial coating prior to the antibacterial coating acquiring a temperature above the second transition temperature.

In some embodiments, the antibacterial coating may destroy and/or inactivates at least about 30%, more specifically at least about 50% and in particular at least about 70% of bacteria on the antibacterial coating within one hour at a temperature below the first transition temperature.

In some embodiments, the antibacterial coating may repel at least about 20%, more specifically at least about 40% and in particular at least about 60% of bacteria within one hour at a temperature above the second transition temperature compared to the number of pathogens on the antibacterial coating prior to the antibacterial coating acquiring a temperature above the second transition temperature.

In a second aspect, the present disclosure relates to a process for manufacturing a flame producing assembly according to any preceding embodiment or combination thereof, wherein the process comprises:
coating a pre-assembled flame producing assembly with a heat conductive layer (28);
coating the pre-assembled flame producing assembly with an antifouling component;
binding a bactericidal component to the antifouling component;
in examples, coating parts of the pre-assembled flame producing assembly with a thermochromic coating.

In a third aspect, the present disclosure relates to a process for manufacturing a flame producing assembly according to any preceding embodiment or combination thereof, wherein the process comprises:
wrapping a pre-assembled flame producing assembly with a heat conductive layer (28);
coating the pre-assembled flame producing assembly with an antifouling component;
binding a bactericidal component to the antifouling component;
in examples, coating parts of the pre-assembled flame producing assembly with a thermochromic coating.

For materials such as highly-oriented polyethylene it may be necessary to in wrap the material around the pre-assembled flame producing assembly, as the orientation may not be provided if the material is coated by undirected processes upon the pre-assembled flame producing assembly. The term “coating” within this disclosure shall refer to the application of material to a surface. A coating process may for example comprise the application of liquids to a surface, which only form a continuous material after the application to the surface. The term “wrapping” within this disclosure shall refer to a coating process, wherein an already continuous material is applied to a surface. A wrapping process may comprise for example applying a plastic sheet to a surface.

In some embodiments, the bactericidal component may be covalently bonded to the antifouling component by surface-initiated photoiniferter-mediated polymerization. In some embodiments, the antifouling component may be coated on the flame producing assembly by electrospinning. In some embodiments, the antifouling component may be coated on the flame producing assembly by dip coating. In some embodiments, the antifouling component may be coated on the flame producing assembly by layer-by-layer self-assembly. In some embodiments, the antifouling component may be coated on the flame producing assembly by initiated chemical vapor deposition. In some embodiments, the antifouling component may be coated on the flame producing assembly by surface initiated reversible addition-fragmentation chain transfer polymerization.

In some embodiments, the flame producing assembly may be a handheld device.

In some embodiments, the flame producing assembly may comprise a fuel container and a means for ignition. In some embodiments, the flame producing assembly may comprise a slow match. In some embodiments, the means for ignition may comprise a flint. In some embodiments, the means for ignition may comprise a spark wheel.

In some embodiments, the means for ignition may comprise a piezo-element. In some embodiments, the means for ignition may comprise a firing pin. In some embodiments, the flame producing assembly may comprise a battery. In some embodiments, the means for ignition may comprise two electrodes.

In some embodiments, the flame producing assembly may comprise a base, a valve, a jet, guard, a fork, a fork spring, a flint spring and/or a ball configured to close the fuel container. In some embodiments, the fuel container may be configured to store a gas, in particular a flammable gas. In some embodiments, the fuel container may be configured to store a liquid, in particular a flammable liquid.

In some embodiments, the flame producing assembly may be characterized by an antibacterial coating, wherein the antibacterial coating is configured to at least partially destroy and/or inactivate pathogens on the antibacterial coating, and wherein the antibacterial coating comprises a bactericidal component and an antifouling component.

In some embodiments, the flame producing assembly may be characterized by an antibacterial coating, wherein the antibacterial coating is configured to at least partially destroy and/or inactivate pathogens on the antibacterial coating, and wherein the antibacterial coating comprises a bactericidal component and an antifouling component, wherein the antifouling component is hydrophobic or hydrophilic.

In some embodiments, the flame producing assembly may be characterized by an antibacterial coating, wherein the antibacterial coating is configured to at least partially destroy and/or inactivate pathogens on the antibacterial coating, and wherein the antibacterial coating comprises a bactericidal component and an antifouling component, wherein the bactericidal component comprises a thermoresponsive polymer.

In some embodiments, the flame producing assembly may be characterized by an antibacterial coating, wherein the antibacterial coating is configured to at least partially destroy and/or inactivate pathogens on the antibacterial coating, and wherein the antibacterial coating comprises a bactericidal component and an antifouling component, wherein the antifouling component is hydrophobic or hydrophilic, and wherein the bactericidal component comprises a thermoresponsive polymer.

In some embodiments, the flame producing assembly may be characterized by an antibacterial coating, wherein the antibacterial coating is configured to at least partially destroy and/or inactivate pathogens on the antibacterial coating, and wherein the antibacterial coating comprises a bactericidal component and an antifouling component, wherein the antifouling component is hydrophobic or hydrophilic, and wherein the bactericidal component comprises a thermoresponsive polymer and wherein the flame producing assembly comprises heat conductive layer configured to transfer thermal energy generated by a flame of the flame producing assembly to the antibacterial coating or wherein the antibacterial coating is thermally conductive.

1. A flame producing assembly with an antibacterial coating, wherein the antibacterial coating comprises a bactericidal component and an antifouling component and is configured to at least partially destroy and/or inactivate pathogens on the antibacterial coating.

2. The flame producing assembly according to claim 1, wherein the antibacterial coating is further configured to at least partially destroy and/or inactivate pathogens on the antibacterial coating below a first transition temperature, wherein the first transition temperature is between about 30° C. to about 50° C.

3. The flame producing assembly according to claim 2, wherein the antibacterial coating is further configured to at least partially repel pathogens and/or remnants thereof.

4. The flame producing assembly according to claim 3, wherein the antibacterial coating is configured to at least partially repel pathogens and/or remnants thereof above a second transition temperature, wherein the second transition temperature is between about 30° C. to about 50° C.

5. (canceled)

6. The flame producing assembly according to claim 1, wherein the bactericidal component comprises a bactericidal agent comprising an antibiotic, an antimicrobial peptide, a polycationic polymer, metal ions, nitric oxide, a nanosized metal, a nanosized metal oxide, an antimicrobial enzyme, a quaternary ammonium salt, an N-halamine and/or a quorum sensing inhibitor.

7. The flame producing assembly according to claim 1, wherein the antifouling component is hydrophobic or hydrophilic.

8. The flame producing assembly according to claim 4, wherein the antibacterial coating is configured to expose the bactericidal component at the outer surface at temperatures below the first transition temperature and to expose the antifouling component at the outer surface at temperatures above the second transition temperature.

9. The flame producing assembly according to claim 4, wherein the bactericidal component or parts thereof are configured to undergo a conformation change when heated above the second transition temperature and to reverse the conformation change when cooling to a temperature below the first transition temperature.

10. The flame producing assembly according to claim 4, wherein the bactericidal component is configured to be in an elongated state at temperatures below the first transition temperature, thereby extending from the outer surface,
and wherein the bactericidal component is in a collapsed state at temperatures above the second transition temperature, thereby resting on the outer surface and/or retracting into the outer surface.

11. The flame producing assembly according to claim 2, wherein the bactericidal component comprises a thermoresponsive polymer.

12. The flame producing assembly according to claim 11, wherein the thermoresponsive polymer comprises poly(N-vinyl caprolactam), poly(N-isopropylacrylamide) and/or poly(N-isopropylacrylamide) co-polymer, more specifically wherein the poly(N-isopropylacrylamide) co-polymer comprises poly(N-isopropylacrylamide-co-caprolactam) and/or poly(N-isopropylacrylamide-co-2-carboxyethyl acrylate).

13. The flame producing assembly according to claim 11, wherein the first transition temperature is a lower critical solution temperature of the thermoresponsive polymer, wherein the lower critical solution temperature is between about 35° C. and about 45° C.

14. The flame producing assembly according to claim 1, wherein the antifouling component forms an outer surface of the antibacterial coating, wherein the bactericidal component is bound to the antifouling component or parts thereof.

15. The flame producing assembly according to claim 4, wherein the first transition temperature and the second transition temperature are the same temperature.

16. The flame producing assembly according to claim 1,
wherein the antifouling component is hydrophobic or hydrophilic,
and wherein the bactericidal component comprises a thermoresponsive polymer.

17. The flame producing assembly according to claim 1, wherein the flame producing assembly comprises a heat conductive layer.

18. The flame producing assembly according to claim 1, wherein the antibacterial coating is thermally conductive.

19. A flame producing assembly with an antibacterial coating, wherein the antibacterial coating is configured to at least partially destroy and/or inactivate pathogens on the antibacterial coating, wherein the antibacterial coating comprises a bactericidal component and an antifouling component, wherein the antifouling component is hydrophobic and/or comprises poly(sulfobetaine methacrylate), and wherein the bactericidal component comprises a thermoresponsive polymer.

20. A process for manufacturing a flame producing assembly according to claim 1, wherein the process comprises: coating a pre-assembled flame producing assembly with a heat conductive layer; coating the pre-assembled flame producing assembly with an antifouling component; binding a bactericidal component to the antifouling component.

21. The process of claim 20, further comprising coating parts of the pre-assembled flame producing assembly with a thermochromic coating.
